(19) United States
(12) Patent Application Publication
(10) Pub. No.: US 2002/0117221 A1
(43) Pub. Date: Aug. 29, 2002

(54) Integration unit

(76) Inventors: Osamu Uchizawa, Miyagi (JP); Yasuhiro Chiba, Miyagi (JP)

Correspondence Address: RANDALL J. KNUTH, P.C., 3510-A Stellhorn Road, Fort Wayne, IN, 46815-4631, US

(21) Appl. No.: 10/005,634

(22) Filed: Dec. 5, 2001

(30) Foreign Application Priority Data
Dec. 6, 2000 (JP) 2000-372055

(51) Int. Cl. F17D 1/00

(52) U.S. Cl. 137/884

(57) ABSTRACT

Provide an integration unit, wherein the does not take part mutually, the reliability becomes an independent one of individual seal portions, improving the reliability than the related art.

An integration unit composed by integrating a plurality of control equipments 10a, 10b, and connecting a flow channel of one control equipment 10a with a flow channel of the other control equipment 10b, wherein a single holding member 11a is disposed in correspondence to one flow channel of the control equipment 10a, and the holding member 11a is fixed only to the corresponding control equipment 10a and not fixed to the other control equipment 10b.

A holding member of the control equipment for the integration unit made of beams and boss portions, wherein the inside is hollow.

### TECHNICAL FIELD

The present invention concerns a control equipment coupling flow channel for coupling respective fluid control equipment and flowing a high purity fluid, in an integration unit for supplying high purity fluid of a gas supply system of a semiconductor, crystal liquid manufacturing apparatus, and valve box or others at the upstream side thereof.

### BACKGROUND ART

Actually, an integrated unit integrating valves, master controller, flow measuring instrument or other control equipment is becoming popular, for the purpose of compacting.

As a representative structure drawing of an integrated unit of the related art, one shown in FIG. 9 can be cited (Laid-Open Japan Patent Application No. HEI 10-311450).

This integrated unit is shown schematically in FIG. 1(a). In FIG. 1(a), as control equipment, a valve 10a and a mass flow controller 10b are taken as example. 11a, 11b, 11c are holding members for holding the control equipment 10a, 10b. The control equipment 10a, 10b is held by the holding member through a flange 12a, 12b. Besides, the holding member is made of a rigid body, and a flow channel formed inside. In short, flow channel 13a-1, 13a-2 are formed in the holding member 11a, flow channel 13b-1, 13b-2 are formed in the holding member 11b, and flow channel 13c-1, 13c-2 are formed in the holding member 11c.

When a control equipment is to be integrated, control equipment 10a, flange 12a, and holding member 11a are aligned so that one flow channel of the control equipment 10a, a hole of the flange 12a, and the flow channel 13a-2 of the holding member 11a come into communication state, and, another flow channel of the control equipment 10a, a hole of the flange 12a, and the flow channel 13b-1 of the holding member 11b come into communication state. Besides, the alignment is performed similarly for the controller 10b. Then, the control equipment 10a is fixedly attached to the holding member 11a and 11b by a bolt or others, through the flange 12a. On the other hand, the control member 10b is fixedly attached to the holding member 11b and 11c by a bolt or others, through the flange 12b.

Holding members 11a, 11b, 11c are fixed to a (not shown) single board or others, at the bottom face thereof, the control equipment is integrated to make an integrated unit.

Howsoever, a flow channel (substrate) coupling respective control equipment through such structure has inconveniences as shown below.

(1) Ordinarily, in case of coupling two (2) control equipments, control equipments are connected using a two-hole (having two (2) seal portions) substrate (block joint). In an integrated unit, essentially by repeating this, control equipment, flange, and substrate are stacked alternately like bricks.

As control equipment, flange, and substrate are tighten up by bolts, a discrepancy of tightening force provoked by a dimensional error of these equipment and substrate occurs.

In the conventional substrate, as its rigidity is high, the discrepancy of tightening force results in influencing on each other.

These mean that seal points (sealed extremely finely) that can not be found practically by the inspection are easily created. This, results in an external leak by vibration, impact or others.

This point is a fatal defect of the conventional integrated unit.

(2) Unnecessarily heavy, because the flow channel is formed in a metal block.

(3) The manufacturing cost is high, because machine processing (oblique hole processing) is performed for forming flow channels in a metal block. This block requires necessarily a high dimensional accuracy because of the aforementioned (1) problem, consequently, resulting in a high cost. In addition, a further cost increase is required for applying electropolishing processing to the inner surface.

(4) Substrates appropriate for valve, MFC (mass flow controller), pressure sensor or other control equipment are required.

(5) For the actual integrated unit, several kinds of method of integrated unit exist, and they are mutually incompatible; consequently

(kind of integrated unit)×(kind of connection (component) of (4)).

This, prevents the actual integrated unit to be standardized, and impedes the total cost cut.

(6) From the viewpoint of control certainty, the gas unit is preferably near the reactor chamber. An ordinary gas unit to be connected by a joint could not be brought close to the chamber because of its important volume; however, by making it an integration unit, its volume was reduced to the order of one fourth (¼) compared to the case of non integration, making possible to install in the vicinity of the chamber. Among them, cases of installation on the chamber side face are increasing; however, in this case, as gas panel, it results in being attached vertically. Being attached vertically, a moment that would not incase of horizontal installation acts on a seal portion between a component and the substrate by the tare of the component (valve, mass flow controller or other control equipment). Consequently, in case of vertical installation, the sealability is inferior to the case of horizontal installation.

(7) Only flow through path of adjacent control equipments can be connected each other.

In the holding member 11a, flow channels 13a-1, 13a-2 are formed, and it is necessary to solve the following (1) to (4) that are defects of the conventional substrate.

(1) Being connection between rigid bodies each other, the risk of external leak occurrence can not be avoided.

(2) Heavy

(3) Different equipments require different substrates.

(4) Different sealing methods require different substrates.

(5) Expensive (manufacturing first cost higher than the gas unit connected by joint without integration).

It is an object of the present invention to resolve the aforementioned defects, and provide an integration unit of high reliability.

### DISCLOSURE OF INVENTION

The integration unit of the present invention is an integration unit composed by integrating a plurality of control equipments, and connecting a flow channel of one control equipment with a flow channel of the other control equipment, wherein:

a single holding member is disposed in correspondence to one flow channel of the control equipment, and the holding member is fixed only to the corresponding control equipment and not fixed to the other control equipment.

Further, the integration unit of the present invention is an integration unit composed by integrating a plurality of control equipment, and connection a flow channel of one control equipment with a flow channel of the other control equipment, wherein:

a single holding member is disposed in correspondence to one control equipment, and the holding member is fixed only to the corresponding control equipment and not fixed to the other control equipment.

The holding member of the control equipment for the integration unit of the present invention is made of beams and boss portions and is characterized by that the inside is hollow.

A flow channel member for the integration unit of the present invention is characterized by that sleeves are connected to both ends of a flexible tube.

A combination structure of the present invention is a combination of a holding member, made of beams and boss portions, of which inside is hollow and a flow channel member where sleeves are connected to both ends of a flexible tube, wherein one of the sleeves is placed on the boss portion.

A connection structure of the present invention is made of beams and boss portions and is characterized by that the inside is hollow, one of sleeves of a flow channel member where the sleeves are connected to both ends of a flexible tube is placed on the boss portion of a holding member where a notch portion is formed on an inner wall of the boss portion, a retainer having a gasket retainer having a double bent extremity portion is interposed between the control equipment and the sleeve and, at the same time, the double bent portion is inserted into said notch portion.

### BRIEF DESCRIPTION OF THE DRAWINGS

FIG. 1(a) shows an example of unit of the related art, and FIG. 1(b) is a drawing showing the integration unit of an embodiment.

FIG. 2 is a perspective view concerning an embodiment 1, and showing a flow channel and a control equipment holding portion.

FIG. 3 is a partially enlarged inside cross portion of FIG. 1(b).

FIG. 4b is a cross portion showing an embodiment 2.

FIG. 5, concerning an embodiment 3, is a six-face view of the control equipment holding portion.

FIG. 6, concerning an embodiment 4, is a cross portion of the flow channel member.

FIG. 7 concerns an embodiment 5, FIG. 7(a) is a conceptual drawing of the integration unit, and FIG. 7(b) is a perspective view of the control equipment holding portion.

FIG. 8, concerning an embodiment 6, is a conceptual drawing of the integration unit.

FIG. 9, concerning an example of the related art, is a front view of the integration unit.

### BEST MODE OF CARRING OUT THE INVENTION

(Embodiment 1)

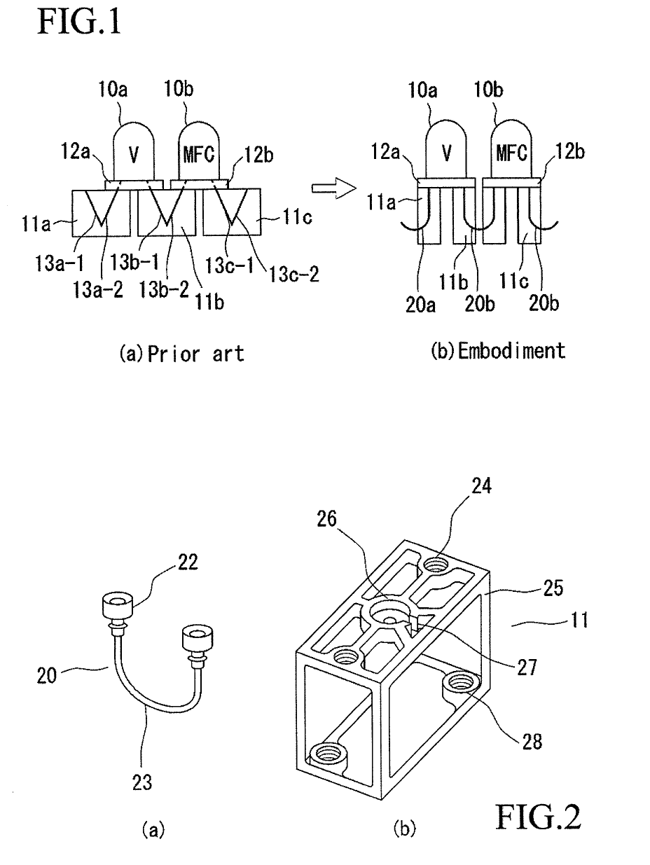

FIG. 1(b) shows the integration unit of an embodiment.

An integration unit composed by integrating a plurality of control equipments 10a, 10b and connecting a flow channel of one control equipment 10a with a flow channel of the other control equipment 10b, wherein a single holding member 11ba is disposed in correspondence to one flow channel of the control equipment 10a.

The detail of the holding member 11a is shown by 11 in FIG. 2.

This holding member 11 is made of a beam 25 and a boss portion 26, and the inside thereof is hollow. Holes 24, 28 are formed in this holding member 11. Besides, the boss portion 26 has a fitting groove 27 formed on the side face thereof.

The hole 24 is the one for screwing and fixing the control equipment 10a to the holding member 11a through a flange 12a, while the hole 28 is the one for attaching and fixing the holding member 11 to a panel or others.

On the other hand, FIG. 2(a) shows a flow channel member 20. A sleeve 22 is disposed at both ends of the flow channel member 20, and a flexible tube 23. Composed of the flow channel member 20, the sleeve 22 and the tube 23, and the sleeve 22 comprises a seal portion corresponding to various kinds of sealing method and a groove portion for (laser) welding of a pipe.

The tube 23 is satisfactory provided that it is flexible, and the piping may be made flexible by using a tube of smaller diameter than ¼″ (outer diameter ø6.35 mm×inner diameter ø4.35 mm) tube which is used ordinarily.

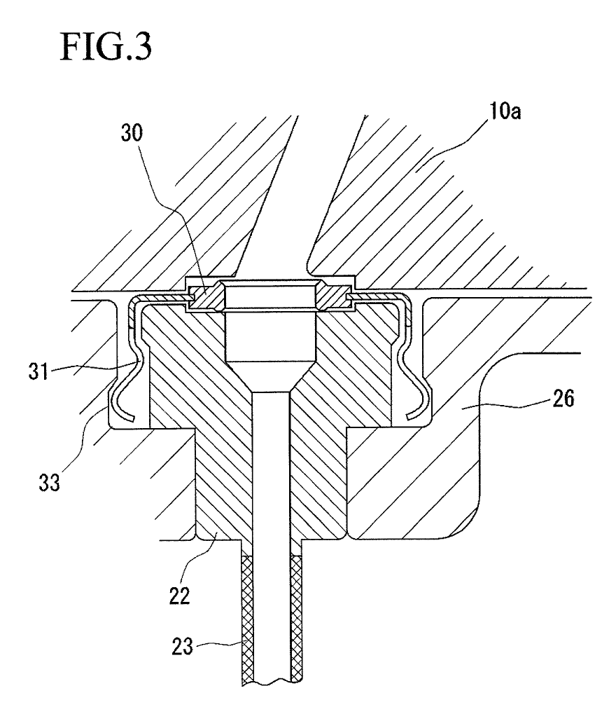

FIG. 3 shows the combination of the flow channel member 20 and the holding member 11.

The tube of the flow channel member 20 is inserted from the fitting groove 27 of the boss portion 26, and the sleeve of the flow channel member 20 is fit into the boss portion. In this example, a shallow recess is provided on the upper part of the sleeve 22, and a gasket 30 is placed in this recess. The gasket 30 is provided with a gasket retainer 31.

The gasket retainer 31 is elastically fixed to the sleeve 22 and the boss portion 26 of the control equipment holding portion 11 by a double bending in notch portion 33 provided in the boss portion inner wall.

Further, a control equipment 10a is screwed on the control equipment holding portion 11.

It should be appreciated that the control equipment holding portion 11 can be formed, for example, by MIM (Metal Injection Molding/metal powder injection molding method). Though, in FIG. 2, a screw connection portion is composed by inserting a helisert into a structure made only of formed beam and ribs, other structures may be adopted. A screw portion 28 in the lower part is offset for allowing to insert a tool from an upper gap portion.

As shown in the drawing, machined portion is totally absent, incurring no manufacturing cost thereof.

(Embodiment 2)

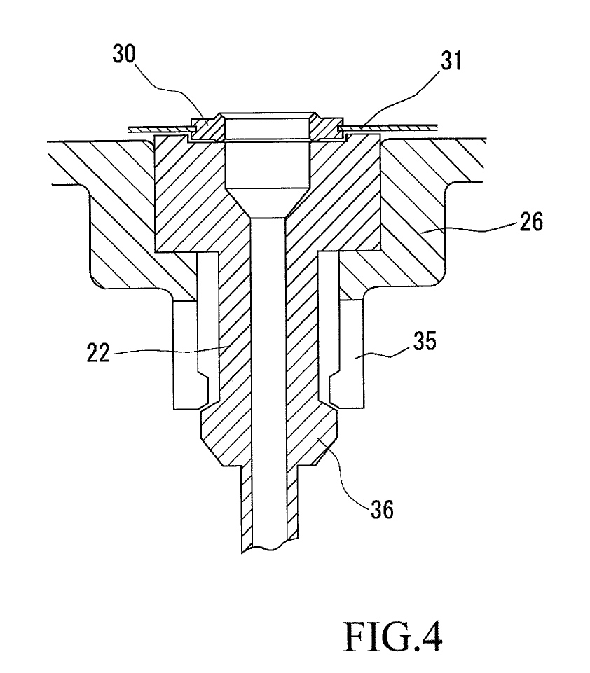

FIG. 4 shows another example.

In this example, a flexible portion 35 is provided at the lower end of the boss portion 26 of the control equipment holding portion 11, and at the same time, a projection portion 35 is provided at a portion where the flexible portion 35 is applied on the outside of the sleeve 22. The sleeve 22 of the flow channel member is elastically fixed by engaging the flexible portion 35 and the projection portion 35.

(Embodiment 3)

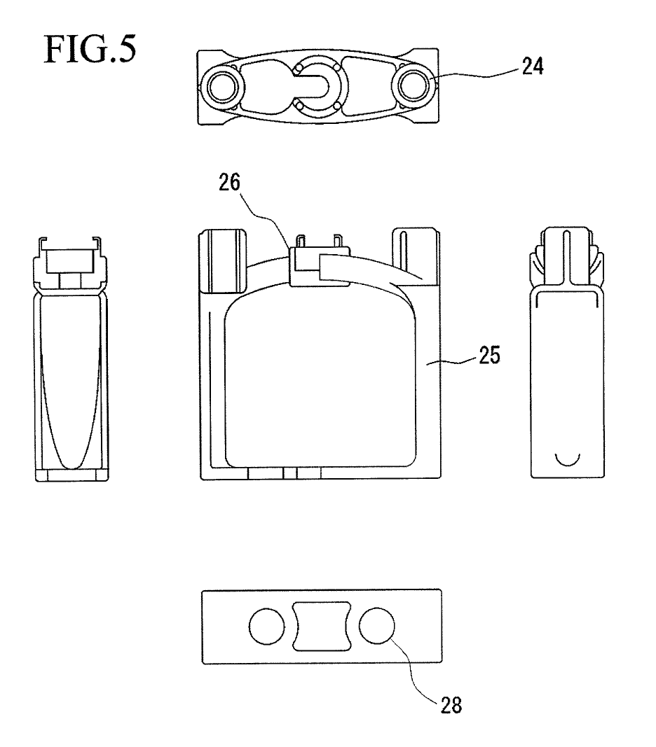

FIG. 5 shows an example of control equipment holding portion.

(Embodiment 4)

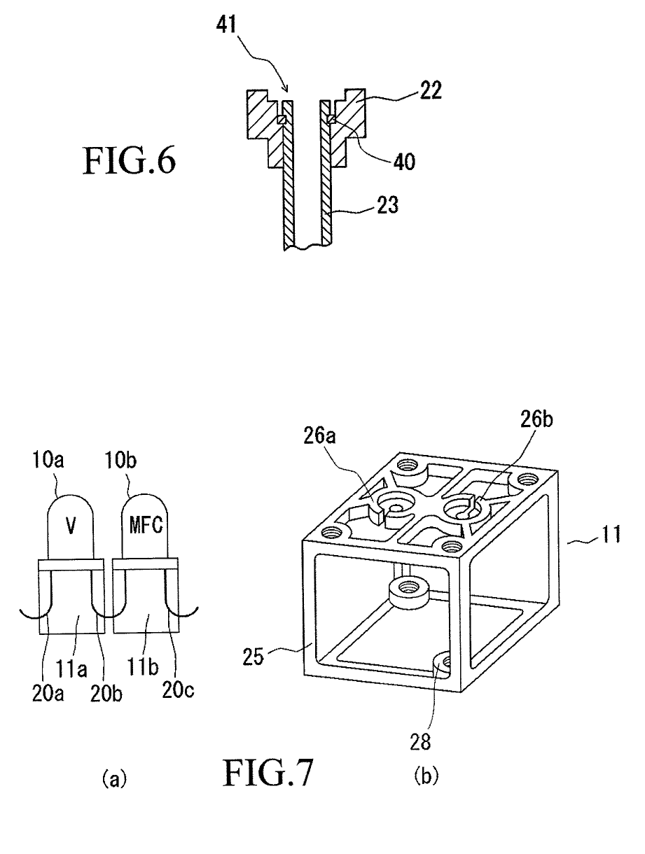

FIG. 6 shows another example.

Though an example for composing the flow channel member by welding the sleeve and the tube, the flow channel member may be composed without using the welding.

In short, there is a structure for retainer piece holding on the outer face of the tube 23, and sealing with a gasket at the tube 23 end face.

Though a C shape ring 40 is used in this example, the sleeve may be held by welding at the tube outer face. Also, tube both ends may be flared for composing a gasket seal face.

(Embodiment 5)

FIG. 7 shows an embodiment 5.

In this example, a single holding member 11a is disposed in correspondence to one control equipment 10a. A single holding member 11b is disposed in correspondence to the other control equipment 10b.

As a plurality of flow channels are formed in the control equipment, a plurality of boss portions 26a, 26b are formed, as shown in FIG. 7(b), in the holding member 11.

In this example also, a mechanical strength connectivity among mutual control equipments is cut off by achieving an independent fastening.

(Embodiment 6)

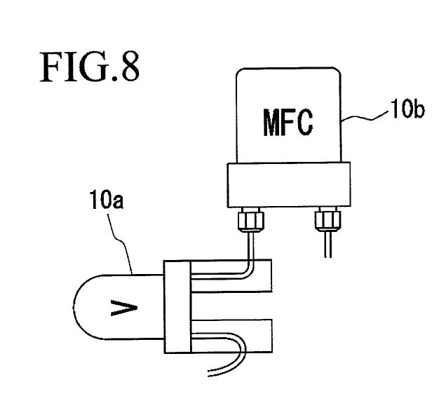

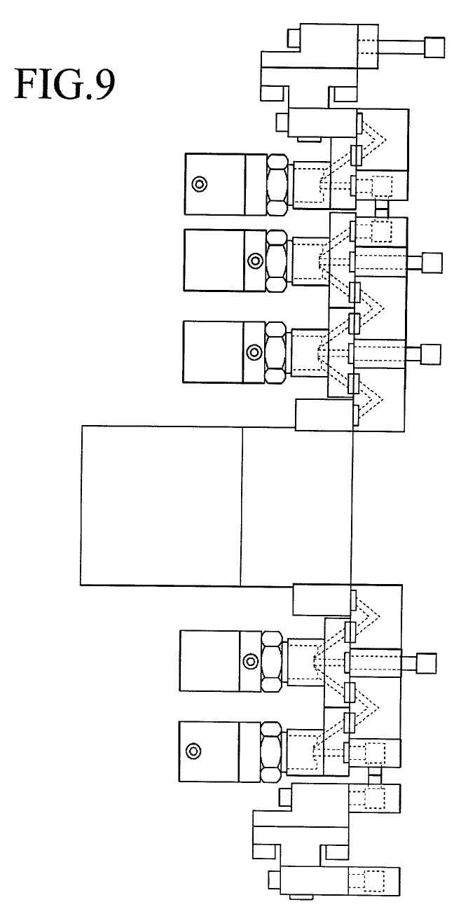

FIG. 8 shows an embodiment 6.

This example is an example where one control equipment 10a and another control equipment 10b are connected in the transversal direction. In the integrated unit of the related art, such transversal connection was impossible.

### INDUSTRIAL APPLICABILITY

The following various effects can be achieved by the present invention.

The defective tightening which was a problem of the rigid body and multiple seal substrate of the related art does not take part mutually, the reliability becomes an independent one of individual seal portions, improving the reliability than the related art.

For the substrate of the related art, the reliability was lower in case of connecting a plurality of the same, and connecting a plurality of lines (systems) than the case of the simple; however, in case of this proposal, the reliability of the simple has become able to be considered at the same level as the reliability of the whole unit.

In addition, having become an independent seal, it has become able be sealed without requiring severely the dimensional accuracy of the substrate itself.

In this proposal, as functions are shared between the control equipment holding portion and the flow channel configuration portion and, moreover, the frame of the control equipment holding portion is limited to the portion necessary in respect of strength, a considerable weight saving (about 1/10 of the substrate of the related art) has been achieved.

Machined portion is totally absent in the control equipment holding portion, incurring no manufacturing cost thereof.

Concerning EP (electropolishing) specifications required as standard to the flow channel, as a simple processing is satisfactory, the cost can be lowered by far compared to the method of the related art where a metal bloc is machined and a complex shape is submitted to the electropolishing.

In the actual integrated unit, as the substrate is different for each sealing method (even if the control equipment is identical), professional assembler manufacturing integration units of various kinds of sealing method is completely absent, and as things stand, assembles cope with the manufacturing only for a certain specific sealing method.

In case of the substrate of the present method, the control equipment holding portion can be used in common, and it is enough to prepare only the seal portion of the flow channel configuration portion, allowing to respond flexibly to the integrated unit of various sealing methods.

As fastened independently (one substrate corresponds to one point of seal portion), accuracy is not required for the mutual positional relationship of seal portions. Consequently, pin or other positioning elements necessary for the substrate of the related art are made unnecessary.

What is claimed is:

1. An integration unit composed by integrating a plurality of control equipments, and connecting a flow channel of one control equipment with a flow channel of the other control equipment, wherein:
a single holding member is disposed in correspondence to one flow channel of the control equipment, and the holding member is fixed only to the corresponding control equipment and not fixed to the other control equipment.

2. An integration unit composed by integrating a plurality of control equipment, and connection a flow channel of one control equipment with a flow channel of the other control equipment, wherein:
a single holding member is disposed in correspondence to one control equipment, and the holding member is fixed only to the corresponding control equipment and not fixed to the other control equipment.

3. A holding member of the control equipment for the integration unit made of beams and boss portions, wherein the inside thereof is hollow.

4. The holding member of the control equipment for the integration unit of claim 3, comprising a single boss portion.

5. The holding member of the control equipment for the integration unit of claim 3, comprising several boss portions.

6. The holding member of the control equipment for the integration unit of any one of claims 3 thought 5, wherein a notch portion is formed on the boss portion inner wall side face.

7. A flow channel member for the integration unit, wherein sleeves are connected to both ends of a flexible tube.

8. The flow channel member for the integration unit of claim 7, wherein the inner diameter of said flexible tube is smaller than the flow channel inner diameter of the control equipment.

9. A combination structure which is a combination of a holding member, composed of beams and boss portions of which inside is hollow, and a flow channel member where sleeves are connected to both ends of a flexible tube, wherein one of the sleeves is placed on the boss portion.

10. A connection structure made of beams and boss portions, wherein the inside is hollow, one of sleeves of a flow channel member where the sleeves are connected to both ends of a flexible tube is placed on the boss portion of a holding member where a notch portion is formed on an inner wall of the boss portion, a retainer having a gasket retainer having a double bent extremity portion is interposed between the control equipment and the sleeve and, at the same time, the double bent portion is inserted into said notch portion.
